(19) United States
(12) Patent Application Publication
(10) Pub. No.: US 2007/0107328 A1
(43) Pub. Date: May 17, 2007

(54) Panel attachment system

(76) Inventor: James A. Munch, Melbourne, FL (US)

Correspondence Address: LITMAN LAW OFFICES, LTD., P.O. BOX 15035, CRYSTAL CITY STATION, ARLINGTON, VA, 22215, US

(21) Appl. No.: 11/471,608

(22) Filed: Jun. 21, 2006

Related U.S. Application Data
(63) Continuation of application No. 11/254,734, filed on Oct. 21, 2005.

(51) Int. Cl. E06B 3/30; E04G 23/00

(52) U.S. Cl. 52/202; 52/745.16; 49/61

(57) ABSTRACT

The panel attachment system includes opposite upper and lower tracks attached to the edges of an opening in a building structure, and one or more panels that secure removably to the tracks to protect the opening from extreme weather, such as hurricane force winds. The upper track has a generally “h” shaped cross section and secures the upper edge of the panel therein. The lower track has a generally “F” shaped cross section, and holds the heads of a series of threaded fasteners in the channel of the track. The threaded shanks of the fasteners protrude outwardly normal to the building structure, pass through holes formed in the lower edge of the panel, and are secured by corresponding nuts. Two or more panels may be joined to cover a wider opening. The panels may be formed of corrugated plastic material.

### REFERENCE TO RELATED PATENT APPLICATION

This application is a continuation in part of U.S. patent application Ser. No. 11/254,734 filed on Oct. 21, 2005, which is hereby incorporated by reference in its entirety.

### BACKGROUND OF THE INVENTION

1. Field of the Invention

The present invention relates generally to panel structures for covering exterior building openings (windows, doors, etc.) for protection from inclement weather, and particularly to a panel attachment system for the removable attachment of protective panels over building openings, e.g., in the manner of storm windows and the like.

2. Description of the Related Art

High winds and severe weather can occur in many parts of the country during certain seasons of the year. Such conditions can be sufficiently prevalent to cause governing bodies to create standards for wind and storm protection in such areas. Examples of the above are found in the Florida State Building Code, which refers back to ASTM E 1996 test standards for large missile impact (i.e., windblown objects). In such areas, it is generally required that openings (doors, windows, etc.) of building structures be covered or secured when a hurricane or similar extreme wind condition is imminent in order to reduce damage to the structure, as well as to reduce the danger from flying shards of glass.

Accordingly, a number of different systems have been developed to meet these standards and to minimize damage to buildings and other structures when such extreme conditions occur. The most basic weather protection system essentially comprises the use of plywood or other wood sheets nailed in place over the door and window openings of a structure. Plywood or similar material of sufficient thickness ( 7/16 inch or thicker) is considered sufficiently strong that it is deemed to meet the ASTM E 1996 test standards for windborne debris. While the installation of plywood or similar panels is effective if carried out properly, such wood panels are relatively heavy and cumbersome, and their removal after the storm has passed leaves nail holes in the structure, which can lead to further damage in tropical and subtropical climates having high humidity and wood boring insects.

As a result of the above, various other protective systems were developed, which do not require the use of nails or similar fasteners that must be removed after penetrating the wood structure. An example of such is permanently installed hinged shutters, which are closed over the window or door openings as needed and reopened when the hazard has passed. While shutter systems can be effective, they can also be unsightly and costly to install, and there is often insufficient room to allow the shutters to fold back along the side of the structure. Moreover, they are not suited for relatively wide spans.

In response to the problems of temporarily attached wood panels and shutter systems, various permanently mounted brackets and the like have been provided, with panels temporarily securing to or within the brackets. This obviates the problem of removal of the fasteners (nails, etc.) from their penetration into the structure, while also avoiding the problems associated with shutter systems. However, such systems known to the present inventor tend to use relatively complex and costly panel configurations (extruded or otherwise specially formed metal, etc.), and/or require special, costly edge components for the panels, which in turn attach to specialized and costly attachment fittings permanently secured to the structure. Moreover, such systems can be relatively complex and time consuming to install and remove, even though their attachment fittings do not require removal from the building structure.

Thus, a panel attachment system solving the aforementioned problems is desired.

### SUMMARY OF THE INVENTION

The panel attachment system has opposed upper and lower extruded tracks or channels, which attach along the upper and lower edges of a window or similar opening in a structure, and one or more panels removably secured to the tracks to protect the opening from extreme weather conditions. The upper track has a generally “h” shaped cross section, with the taller flange being secured permanently to the structure (window frame, etc.), and the channel of the track defined by the two depending legs of the “h” serving to hold the upper edge of the panel in place. The lower track has an “F” shaped cross section, with the wider flange again serving to secure the track permanently to the structure and the two parallel arms of the “F” defining a track channel having retaining lips extending therefrom and holding the heads of a series of threaded fasteners therein. The lower edge of the panel includes a corresponding series of holes therethrough, which fit over the protruding shanks of the fasteners and are secured to the fasteners by cooperating nuts. The opposite lateral or vertical edges of the panel may be secured to the corresponding edges of the opening by a series of flush or protruding fasteners, depending upon the installation.

The panels are preferably formed of corrugated sheets of high-impact plastic material, e.g., high density polypropylene or the like. Such corrugated plastic sheet provides good strength due to the thickness and spacing of the corrugations, while still being relatively lightweight. Other types of plastic or composite material may be used as desired, but it has been found that the use of corrugated polypropylene plastic material of about ⅝ inch thickness provides good economy while meeting the ASTM E 1996 and Florida State Building Code requirements. Two or more such panels may be joined edge-to-edge to cover a wider opening by means of an appropriately configured extrusion that grips one panel edge and receives the adjacent panel edge.

These and other features of the present invention will become readily apparent upon further review of the following specification and drawings.

### BRIEF DESCRIPTION OF THE DRAWINGS

FIG. 1 is an environmental, perspective view of a panel attachment system according to the present invention as installed, on a building structure, showing its general features.

FIG. 2 is an environmental perspective view of a panel attachment system according to FIG. 1, showing a first method of attaching the panels to the structure.

FIG. 3 is an environmental perspective view of a panel attachment system according to FIG. 1, showing an alternative method of attaching the panels to the structure.

FIG. 4 is a detailed side elevation view in section of the lower edge of the panel attachment system installation of FIG. 1, showing further details thereof.

FIG. 5 is a detailed side elevation view in section of the upper edge of the panel attachment system installation of FIG. 1, showing further details thereof.

FIG. 6 is a detailed top plan view in section of the opposite lateral edges of the panel attachment system installation of FIG. 1, showing further details thereof.

FIG. 7 is a detailed top plan view in section of the center of the panel attachment system installation of FIG. 1, showing further details thereof.

Similar reference characters denote corresponding features consistently throughout the attached drawings.

### DETAILED DESCRIPTION OF THE PREFERRED EMBODIMENTS

The present invention comprises various embodiments of a panel attachment system adapted particularly for use as storm window panels over door and window openings in building structures, but suitable for use in other environments as well. Upper and lower tracks or channels are permanently installed immediately above and below the structural opening, with one or more protective panels removably secured to the tracks to protect the door or window opening.

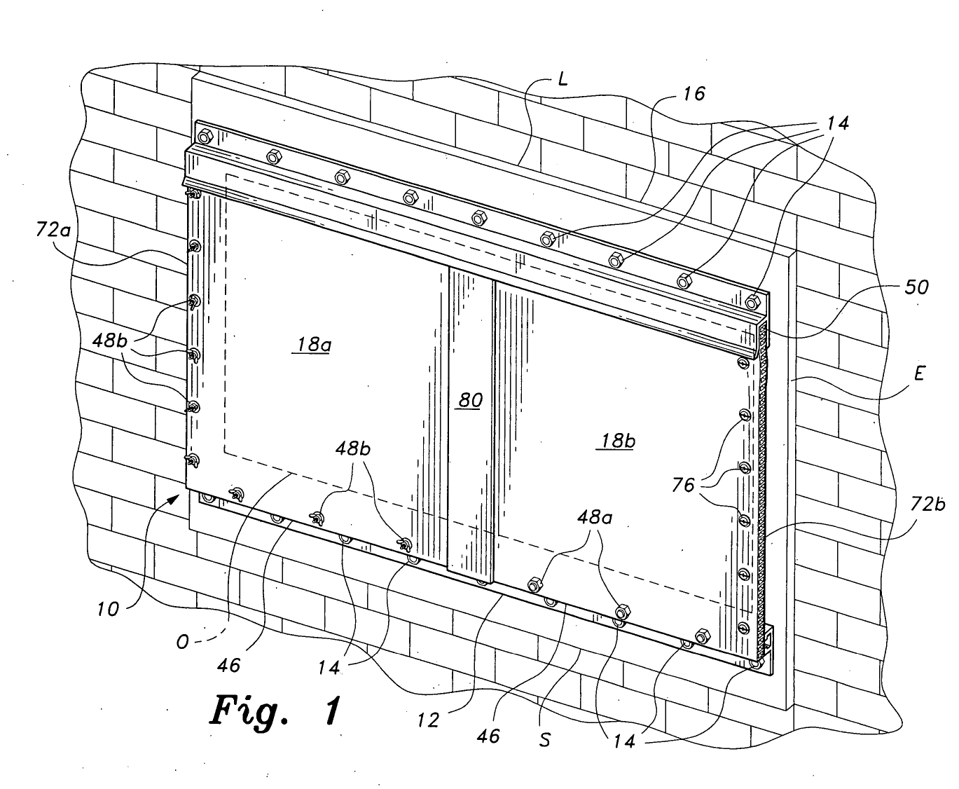

FIG. 1 of the drawings illustrates an exemplary installation of the panel attachment system, designated generally as system or panel installation assembly 10. A continuous, generally horizontal lower track 12 is permanently secured to the sill S or lower trim board of the structural opening O by a series of fasteners 14, e.g., lag bolts, threaded studs and nuts, wood screws, etc. A continuous, generally horizontal upper track 16 is permanently secured to the upper lintel L or trim board of the opening substantially parallel to the lower track 12, generally using the same type(s) of fasteners 14. The lower and upper tracks 12 and 16 are preferably formed of aluminum extrusions, but other manufacturing principles may be used to form the tracks 12 and 16, as desired.

One or more panels 18a, 18b, etc., are removably secured over the opening by the two tracks or channels 12 and 16. The opposite lateral or vertical edges of the panels 18a, 18b may be secured to the lateral edges E or trim boards of the opening by a series of fasteners (described in detail further below), which are, in turn, permanently installed to the edges E of the structural opening. The panels 18a, 18b, etc. may be formed of any suitable material, e.g., plywood or other composite board, solid or hollow core plastic sheets, composite fibers (e.g., fiberglass), etc., as desired. However, the panels 18a and 18b are preferably formed of a corrugated polypropylene plastic material, which has been found to provide optimum characteristics of light weight, flexibility, weather and sun resistance, insect resistance, and good resistance to impact by wind blown objects. (The term “corrugated” is used here to describe the configuration of the panels 18a and 18b as generally having a series of spaced apart internal webs connecting opposed smooth outer surface sheets and defining a series of parallel flutes of rectangular or other cross section therebetween, and is not limited to an internal configuration comprising a continuous web sheet having a series of alternating folds therein.)

The material is relatively thick, e.g., on the order of sixteen millimeters, or ⅝ inch, with other thicknesses usable as desired. The relatively thin front and back surfaces allow reasonably good light passage therethrough, with the panels thus being translucent. This provides the advantage of reasonably good natural daylight for the interior illumination of a structure when such panels are secured in place over the structural openings, which can be an important consideration in the event of power failure during a storm.

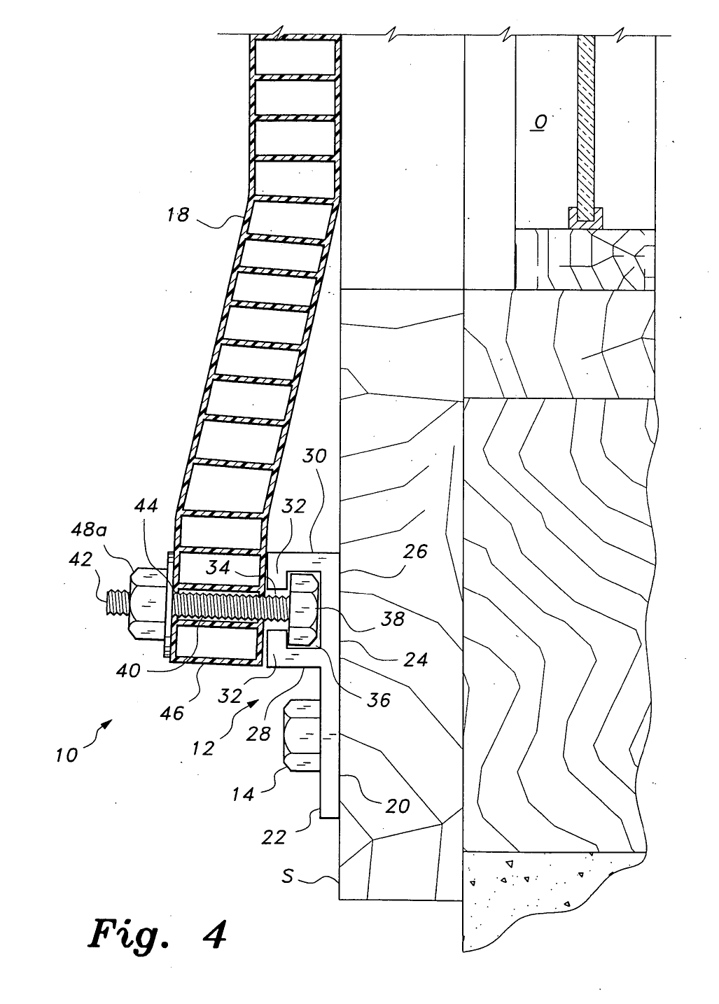

FIG. 4 of the drawings provides a detailed elevation view in section of the lower track or channel component 12. The lower track or channel 12 has a generally “F” shaped cross section (shown in mirror image in the right hand view of FIG. 4), with an attachment flange 20 forming the vertical component of the shape. The attachment flange 20 has a lower edge 22, a medial portion 24, and an upper edge 26, with a lower rail 28 extending from the medial portion of the flange 20 substantially normal thereto, and an upper rail 30 extending from the upper edge of the flange 20 substantially parallel to the lower rail 28. Each rail 28 and 30 has a distal lip 32 extending therefrom. The two lips 32 face toward one another to provide a narrower slot 34 therebetween opposite the attachment flange 20, with a fastener head retaining channel 36 defined between the two rails 28 and 30, the two lips 32 and the attachment flange 20.

The channel 36 captures the head 38 of a conventional threaded fastener 40 therein, with the two lips 32 precluding departure of the fastener head 38 through the narrower slot 34. The only means of installing or removing the fastener 40 to and from the lower track 12 is by inserting or removing the fastener head 38 into or from the open end of the track 12. This allows the position of the fasteners 40 to be adjusted as desired for proper spacing and alignment with preformed holes adjacent the lower edge(s) of the panel(s) 18. However, the positions of the fasteners 40 in the track 12 may be temporarily or permanently fixed in place, e.g., by adhesive, by staking either or both of the rails 28 and/or 30, by spacers within the channel 36 between the bolt heads, etc.

The threaded shank 42 of the fastener 40 extends outwardly from the channel 36 of the lower track 12, generally normal to the track attachment flange 20 and to the surface of the structure to which the lower track 12 is secured. The panel(s), e.g., single panel 18 of FIG. 4, is provided with a series of preformed lower track attachment holes or passages 44 therethrough adjacent the lower edge 46 thereof corresponding in number to the fasteners 40 installed in the channel 36 of the lower track 12. The threaded shanks 42 of the fasteners 40 pass through the lower holes or passages 44 of the panel(s) 18, 18a, 18b, etc., with the panel(s) 18, 18a, 18b, etc. being secured to the fasteners 40 (and thus to the underlying lower track 12) by cooperating nuts, e.g., hexagonal nuts 48a as shown in FIG. 4 and the right side of FIG. 1, or alternatively by wing nuts 48b, as shown along the left side of FIG. 1.

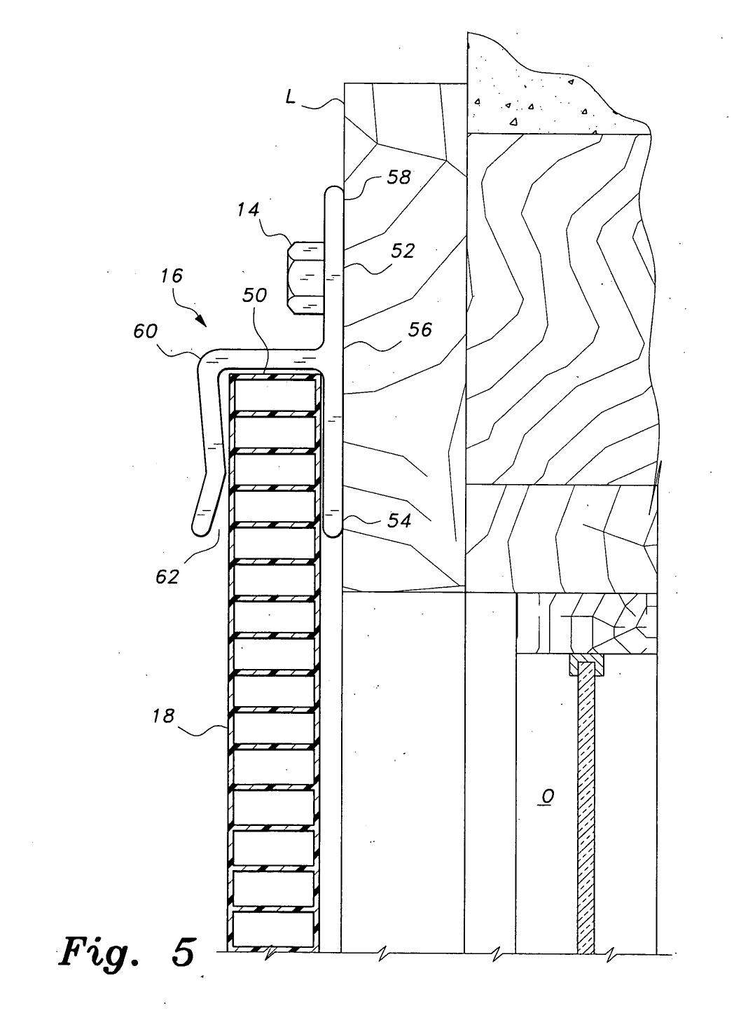

FIG. 5 provides a detailed elevation view in section of the upper track 16 and the installation of the upper edge 50 of the panel 18 therein. The upper track or channel 16 has a generally “h” shaped cross section, as shown in mirror image in the right end elevation view of FIG. 5. The track 16 includes an attachment flange 52, which serves to attach the track 16 to the upper lintel L or trim board of the opening O. The upper track attachment flange 52 has a lower edge 54, a medial portion 56, and an upper edge 58, with a downwardly oriented angle 60 extending from the medial portion of the flange 52. The angle 60 and lower portion of the attachment flange 52 define a downwardly facing panel edge retaining channel 62 therebetween, which accepts the upper edge 50 of the panel 18 therein. No additional fasteners are required to secure the upper edge 50 of the panel 18 within the channel 62 of the upper track 16, as the panel 18 cannot drop downwardly from the channel 62 due to attachment of the substantially parallel lower edge 46 of the panel to the lower track 12.

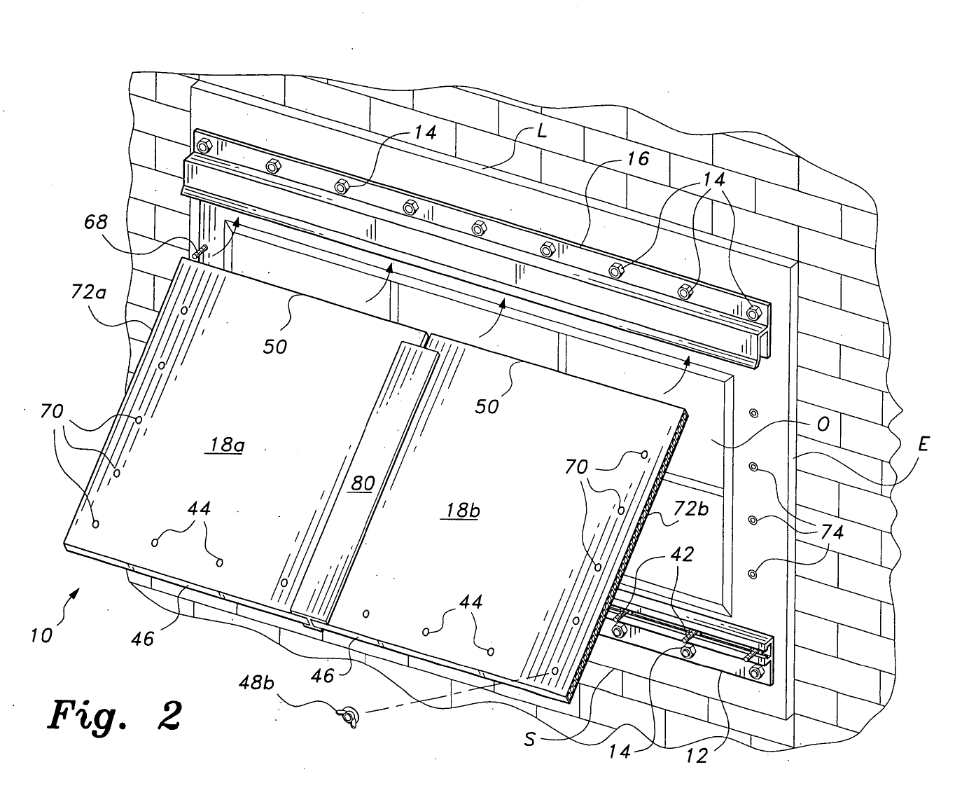

The panel 18, or plural panel assembly 18a, 18b, etc., may be secured removably to the two tracks 12 and 16 in different ways. FIG. 2 illustrates a first panel attachment method, in which the panel lower edge fasteners 40 are first installed in the lower track 12 with their threaded shanks 42 extending therefrom. The panel(s) 18a, 18b, etc. are secured in place by first inserting their upper edges 50 into the downward facing channel of the upper track 16. The opposite lower edges 46 of the panels are then swung inwardly, i.e., toward the wall of the structure and the lower track 12 attached thereto, with the lower edge holes or passages 44 passing over the shanks 42 of the fasteners extending from the lower track 12. Suitable attachment nuts may then be installed over the ends of the fastener shanks 42 to secure the lower edge(s) 46 of the panel(s) in place. Either the hexagonal nuts 48a or wing nuts 48b may be used, but preferably wing nuts 48b are used in this installation method, as the nuts must be installed and removed individually at each installation and removal of the panels 18, 18a, 18b from the structure. The use of wing nuts facilitates this task and obviates the need for additional tools or equipment.

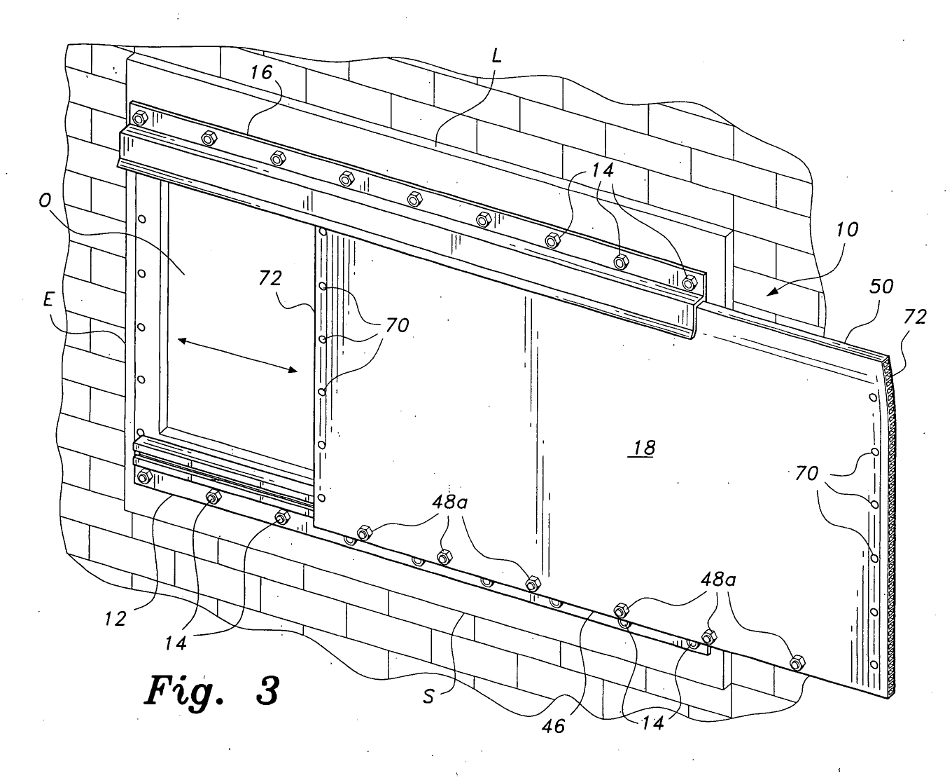

FIG. 3 illustrates an alternative panel installation method in which the lower edge fasteners 40 are left permanently installed through the lower edge of the panel 18, as evidenced by the visible hexagonal nuts 48a along the panel lower edge as shown in FIG. 3. In this instance, the upper and lower edges 46 and 50 of the panel 18 are simultaneously secured to or within the lower and upper tracks 12 and 16 by sliding the panel 18 to engage the channels of the tracks 12 and 16 from the ends thereof. The heads of the lower track fasteners 40 protrude from the back side of the panel 18, generally as shown in FIG. 4, and are slid laterally into the open end of the channel of the lower track 12 simultaneously with the lateral insertion of the upper edge 50 of the panel into the channel of the upper track 16. This method has the advantage of obviating any requirement for the installation of additional fasteners along the lower edge of the panel at the time of panel installation, and may be used where there is no protruding structure (e.g., cornices, walls, etc.) immediately adjacent the opening over which the panel 18 is to be secured and extending outwardly from the wall.

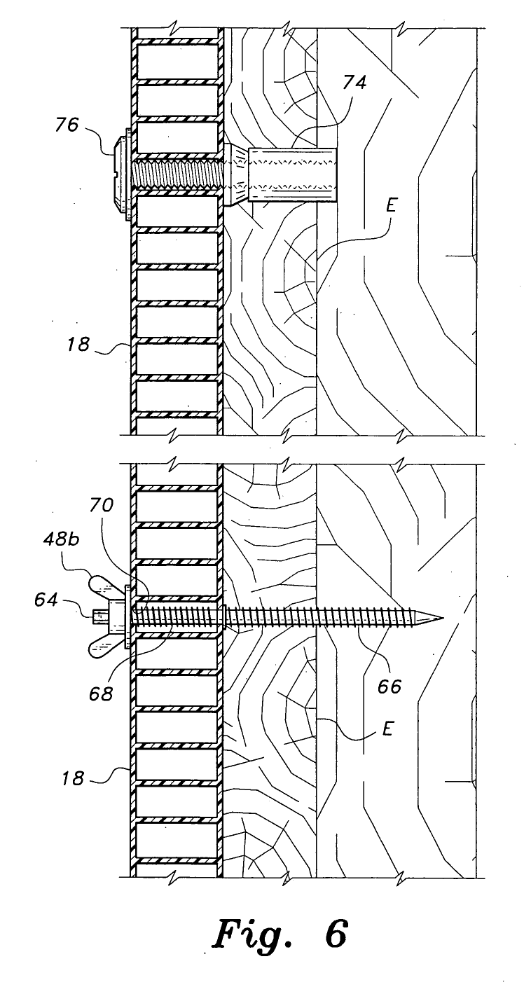

The panel attachment system 10 also provides for securing the opposite lateral outboard edges of the panel(s) to the structure. FIG. 6 provides a detailed plan view in section of two exemplary lateral edge-fastening devices, which are also illustrated more generally in FIGS. 1 through 3. It will be understood that these two types of lateral edge fasteners may be installed with one another, as shown in FIG. 6. However, preferably only a single type will be used in any given installation in order to simplify the installation procedure. It will also be noted that the vertical or plan view of FIG. 6 shows an end view of the corrugations or flutes of the panel(s) 18, i.e., ninety degrees to the panel orientation shown in FIGS. 1 through 5. This is intentional in order to show the different orientations that may be used with the present panel system 10. The flute or corrugation orientation is not part of the present invention.

The lateral edge fastener 64 shown in the lower portion of FIG. 6 is a double-ended externally threaded fastener, with the permanently installed portion 66 having a tapered thread formed thereon (i.e., wood screw configuration) and the opposite portion 68 extending outwardly from the edge trim or structure E having a constant diameter threaded shank, i.e., machine screw configuration. This type of fastener is conventional, and is known by the trade name “Tapcon”. The fastener 64 is permanently installed in the structure, and preformed holes or passages 70 (shown more clearly in FIGS. 2 and 3) formed through the panel 18a, 18b adjacent the parallel lateral outboard edges 72a and 72b thereof (or edges 72, for the single panel 18 as shown in FIG. 3) are passed over the outwardly extending machine screw portions 68 of the fasteners 64 and secured using a suitable internally threaded fastener, e.g., wing nuts 48b, etc.

It will be seen that the lateral edges 72 (or 72a, 72b) of the panel must be lifted outwardly to provide clearance over the protruding outer portions 68 of the fasteners 64 during installation, as shown in the installation method of FIG. 2. However, such permanently installed protruding lateral edge fasteners 64 are quite suitable for securing the lateral edges 72, 72a, or 72b of the panels when the panel lower edge fasteners 40 have been first placed within the lower track 12, rather than first being permanently installed through the panel lower edge attachment holes 44 of the panel(s).

The upper portion of FIG. 6 illustrates an alternative lateral or outboard edge fastening system comprising flush-mounted internally threaded anchors 74 and machine threaded bolts or screws 76, as shown more generally along the right edge of the panel 18b of FIG. 1. The internally threaded anchors 74, e.g., expansion lugs or anchors, etc., may be used in masonry or other materials as desired. This type of installation is well-suited when the panel(s) 18, 18a, 18b, etc. is/are to be installed according to FIG. 3, i.e., slid onto or into the two tracks 12 and 16 simultaneously, where the panel(s) cannot be pulled outwardly from the wall structure to any great degree to clear the protruding threaded studs 68. In this instance, the panels are positioned with their lateral edge holes 70 aligned with the underlying flush anchors 74, and machine bolts or screws 76 are installed through the panel edge holes 70 and into the anchors 74. While the bolt or screw 76 illustrated in FIG. 6 is shown with a slotted head requiring a screwdriver or the like, it will be seen that a conventional winged head may be provided for the edge bolt in order to obviate any requirement for tools to secure the lateral edges of the panel(s).

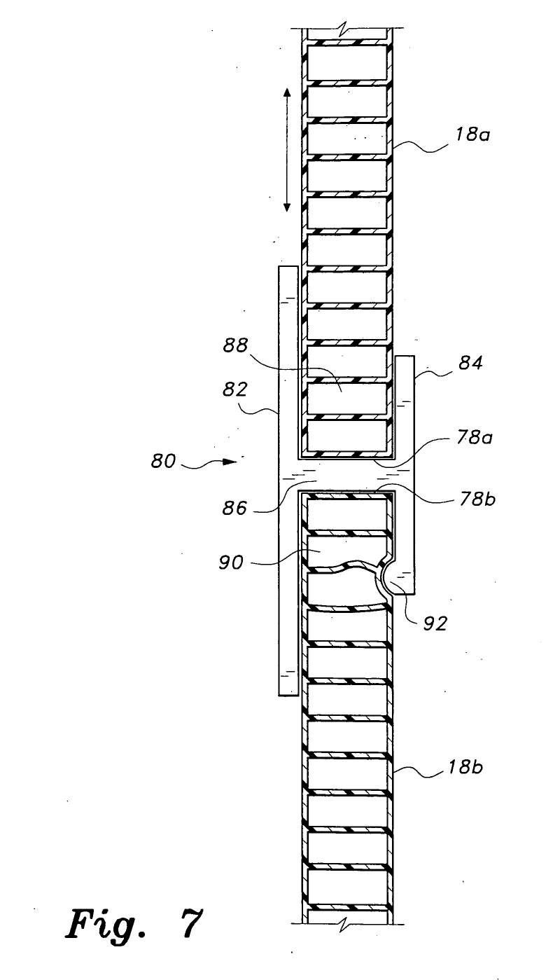

The panel attachment system 10 provides for more than a single panel to be installed over or across a given opening in a structure. Where the opening is wider or larger than the span of a single panel, plural panels may be temporarily joined together by means of an elongate panel connector strip. FIG. 7 provides a detailed plan view of such a panel connector installation. In FIG. 7, first and second panels 18a and 18b are joined together at their adjacent panel connector edges, respectively 78a and 78b, opposite their lateral or outboard edges 72a and 72b (shown in FIGS. 1 and 2) by a panel connector 80. As in the case of other panels 18, 18a, and 18b shown in other drawing Figs., the first and second panels 18a and 18b are preferably formed of corrugated polypropylene plastic material, but other suitable sheet materials may be used. While only two joined panels 18a and 18b are illustrated in FIGS. 1, 2, and 7, it will be seen that any practicable number of panels 18 may be joined by a series of panel connectors 80.

The elongate panel connector 80 has a generally “H” shaped cross section, with an outer or first flange 82, an opposite inner or second flange 84 substantially parallel to the first flange 82, and an intermediate web 86 joining the two flanges 82 and 84 to one another and spacing them apart from one another. The two flanges 82, 84 and their intermediate web 86 define opposite first and second panel connector edge retaining channels therein, respectively first channel 88 and second channel 90. The two channels 88 and 90 are coplanar with one another due to the flat configuration of the two flanges 82 and 84. The panel connector edge 78a of the first panel 18a is placed within the first channel 88 of the panel connector 80, with the panel connector edge 78b of the second or last panel 18b being placed within the corresponding second channel 90 of the panel connector.

While not a requirement, it is preferred that means be provided for permanently securing the panel connector 80 to one of the panel connector edges 78a or 78b of the corresponding panels 18a and 18b, while providing for the removable installation of the opposite panel connector edge to the panel connector 80. This simplifies the assembly of multiple panels to one another, as the panel connector strip 80 remains permanently attached to one of the panels. This may be accomplished as shown in FIG. 7, by forming an inwardly directed bead or lip 92 along one edge of one of the flanges, e.g., the second channel edge of the second flange 84, as shown in FIG. 7. This inwardly directed bead 92 defines a gap or space between it and the inner surface of the opposite flange 82, which is narrower than the thickness of the panel 18b inserted within the channel 90. Accordingly, the panel 18b is deformed somewhat adjacent to its panel connector edge 78b as the bead or lip 92 grips the panel, thereby permanently attaching the connector strip 80 to the panel 18b.

In conclusion, the panel attachment system in its various embodiments greatly facilitates the installation and removal of protective panels over structural openings and the like. The opposite tracks to which the panels are secured need only be installed once to the edges of the opening, with the panel itself or panels themselves being quickly and easily installed and removed from the tracks. The preferred corrugated polypropylene panels are quite light in comparison to conventional panels of plywood and similar heavy materials, and are thus much easier to manipulate, install, and remove. The translucence of the panels provides additional advantages in extreme weather conditions, when loss of electrical power and lighting is likely. Accordingly, the panel attachment system will enable users to install such protective panels much more quickly than is the case with conventional panels and systems.

It is to be understood that the present invention is not limited to the embodiments described above, but encompasses any and all embodiments within the scope of the following claims.

I claim:

1. A panel attachment system, comprising:
an elongated upper track defining a generally downward facing panel edge retaining channel therein;
an elongated lower track substantially parallel to the upper track, the lower track defining a channel having a retainer slot extending axially along the channel;
a plurality of panel lower edge fasteners, each of the fasteners having a head slidably disposed within the fastener head retaining channel of the lower track and a shank extending through the retainer slot, the shank having a threaded portion extending outwardly from the lower track; and
at least one panel having an upper edge, a lower edge opposite the upper edge, and mutually opposed first and second lateral edges, the lower edge of the panel having a plurality of fastener passages disposed adjacent the lower edge, the upper edge being removably installed within the edge retaining channel of the upper track, the fastener shanks extending through the fastener passages defined in the at least one panel.

2. The panel attachment system according to claim 1, wherein said at least one panel is formed of corrugated plastic material, the first and second lateral edges of said at least one panel each having a plurality of fastener passages disposed adjacent thereto, the system further comprising a plurality of lateral edge fasteners removably disposed through the fastener passages of the first and second lateral edges of said panel.

3. The panel attachment system according to claim 2, wherein said plurality of lateral edge fasteners comprises protruding machine threaded studs and wing nuts.

4. The panel attachment system according to claim 2, wherein said plurality of lateral edge fasteners comprises internally threaded anchors and bolts.

5. The panel attachment system according to claim 1, wherein said at least one panel comprises at least a first panel and a last panel, the panels being formed of corrugated plastic material, the panels each having an outboard edge and a plurality of fastener passages defined adjacent the outboard edge, each of the panels having at least one panel connector edge, the panel connector edge of the first panel and the last panel being opposite the respective outboard edge thereof, the system further comprising:
a plurality of outboard edge fasteners removably disposed through the outboard edge of the first and the last panel; and
at least one elongate panel connector having a first flange, a second flange spaced apart from and parallel to the first flange, and an intermediate web joining the first flange to the second flange, the first flange, second flange, and web defining coplanar, mutually opposed panel connector edge retaining channels therein, the panel connector edge of each of the panels being disposed within one of the panel connector edge retaining channels of the at least one panel connector.

6. The panel attachment system according to claim 5, further including an inwardly directed bead disposed along the edge of the first flange in order to define a narrow connector edge retaining channel permanently gripping the panel when installed thereon.

7. The panel attachment system according to claim 1, wherein said at least one panel is formed of translucent material.

8. The panel attachment system according to claim 1, wherein said upper track and said lower track are each formed of an extruded aluminum.

9. A panel attachment system, comprising:
an elongated upper track defining a panel edge retaining channel therein;
an elongated lower track disposed substantially parallel to the upper track, the lower track defining a panel edge-retaining channel therein;
at least one panel formed of corrugated plastic material, the panel having an upper edge removably secured within the panel edge retaining channel of the upper track and a lower edge opposite the upper edge, the lower edge being removably secured to the panel edge retaining channel of the lower track, and the panel further having mutually opposed first and second lateral edges and a plurality of fastener passages defined therein adjacent the lower edge and the first and second lateral edges; and
a plurality of lateral edge fasteners removably disposed through the first and second lateral edges of the panel.

10. The panel attachment system according to claim 9, wherein said lower track comprises an attachment flange having a lower edge, a medial portion, and an upper edge, a lower rail extending from the medial portion of the attachment flange, an upper rail extending from the upper edge of the attachment flange, each of the rails having a distal lip extending normal thereto, each of the lips facing one another, the rails and lips collectively defining a fastener head retaining channel therein and a slot disposed opposite the attachment flange, the lower edge of said at least one panel having a plurality of fastener passages disposed adjacent thereto, the system further comprising a plurality of panel lower edge fasteners, each of the fasteners having a head adjustably disposed within the fastener head retaining channel of said lower track, the head being retained therein by the rail distal lips, the fasteners having a threaded shank extending generally horizontally outwardly therefrom, the lower edge of said at least one panel being removably secured to said lower track by said panel lower edge fasteners being disposed through the fastener passages of the lower edge of said at least one panel.

11. The panel attachment system according to claim 9, wherein said at least one panel comprises at least a first panel and a last panel, the panels being formed of corrugated plastic material, the panels each having an outboard edge and a plurality of fastener passages defined adjacent the outboard edge, each of the panels having at least one panel connector edge, the panel connector edge of the first panel and the last panel being opposite the respective outboard edge thereof, the system further comprising:
a plurality of outboard edge fasteners removably disposed through the outboard edge of the first and the last panel; and
at least one elongate panel connector having a first flange, a second flange spaced apart from and parallel to the first flange, and an intermediate web joining the first flange to the second flange, the first flange, second flange, and web defining coplanar, mutually opposed panel connector edge retaining channels therein, the panel connector edge of each of the panels being disposed within one of the panel connector edge retaining channels of the at least one panel connector.

12. The panel attachment system according to claim 11, further including an inwardly directed bead disposed along the edge of the first flange in order to define a narrow connector edge retaining channel permanently gripping the panel when installed thereon.

13. The panel attachment system according to claim 11, wherein said plurality of outboard edge fasteners comprises protruding machine threaded studs and wing nuts.

14. The panel attachment system according to claim 9, wherein said plurality of lateral edge fasteners comprises internally threaded anchors and bolts.

15. The panel attachment system according to claim 9, wherein said at least one panel is formed of translucent material.

16. The panel attachment system according to claim 9, wherein said upper track and said lower track are each formed of extruded aluminum.

17. A panel attachment system, comprising:
an elongated upper track defining a panel edge retaining channel therein;
an elongated lower track disposed substantially parallel to the upper track, the lower track defining a panel edge retaining channel therein;
a first panel and a second panel formed of corrugated plastic material, each of the panels having an upper edge removably secured within the panel edge retaining channel of the upper track, a lower edge opposite the upper edge removably secured to the panel edge retaining channel of the lower track, a panel connector edge, and an opposing outboard edge, the panel having a plurality of fastener passages defined therein adjacent the lower edges and the outboard edges;
a plurality of outboard edge fasteners removably disposed through the outboard edges of the first and second panels; and
an elongate panel connector having a first flange, a second flange spaced apart from and parallel to the first flange, and an intermediate web joining the first flange to the second flange, the first flange, second flange, and web defining coplanar, mutually opposed panel connector edge retaining channels therein, the panel connector edges of the first and second panels being disposed within one of the panel connector edge retaining channels of the panel connector.

18. The panel attachment system according to claim 17, further including an inwardly directed bead disposed along the edge of the first flange in order to define a narrow connector edge retaining channel permanently gripping the panel when installed thereon.

19. The panel attachment system according to claim 17, wherein said lower track comprises an attachment flange having a lower edge, a medial portion, and an upper edge, a lower rail extending from the medial portion of the attachment flange, an upper rail extending from the upper edge of the attachment flange, each of the rails having a distal lip extending normal thereto, each of the lips facing one another, the rails and lips collectively defining a fastener head retaining channel therein and a slot disposed opposite the attachment flange, the lower edge of said at least one panel having a plurality of fastener passages disposed adjacent thereto, the system further comprising a plurality of panel lower edge fasteners, each of the fasteners having a head adjustably disposed within the fastener head retaining channel of said lower track, the head being retained therein by the rail distal lips, the fasteners having a threaded shank extending generally horizontally outwardly therefrom, the lower edge of said at least one panel being removably secured to said lower track by said panel lower edge fasteners being disposed through the fastener passages of the lower edge of said at least one panel.

20. The panel attachment system according to claim 17, wherein said plurality of outboard edge fasteners comprises protruding machine threaded studs and wing nuts.

21. The panel attachment system according to claim 17, wherein said plurality of outboard edge fasteners comprises internally threaded anchors and bolts.

22. The panel attachment system according to claim 17, wherein at least one said panel is formed of translucent material.

23. The panel attachment system according to claim 17, wherein said upper track and said lower track are each formed of extruded aluminum.

24. A panel system for covering an exterior building opening, comprising:
at least one panel having an upper edge, a lower edge opposite the upper edge, and mutually opposed first and second lateral edges, the lower edge of the panel having a plurality of fastener passages disposed adjacent the lower edge;
a plurality of panel lower edge fasteners having a head and a shank extending from the head, the shanks extending through the fastener passages of the panel;
means for removably attaching the at least one panel to the building in order to cover the exterior building opening.

25. The panel system according to claim 24, wherein said means for removably attaching comprises:
an elongated upper mount having:
a back plate having an upper portion, a medial portion, and a lower portion; and
an angle extending from the medial portion, the angle having a flange extending substantially parallel to the lower portion of the back plate so that the upper mount is substantially h-shaped, the upper portion being adapted for attachment to the building above the building opening, the angle opening downward to define an upper track; and
an elongated lower mount having:
a back plate having an upper portion, a medial portion, and a lower portion;
an upper rail extending substantially normal to the upper portion of the lower mount back plate, the upper rail having a downward extending distal lip; and
a lower rail extending substantially normal to the medial portion of the lower mount back plate so that the lower mount is substantially F-shaped, the lower rail having an upward extending distal lip, the lower portion of the back plate being adapted for attachment to the building, the lower mount defining a lower track bounded by the back plate, upper and lower rails and distal lips, the distal lips defining a slot therebetween;
wherein the upper edge of said panel is slidable into the upper track and the heads of said fasteners are slidable in the lower track with the shanks extending through the slot defined by the distal lips in order to cover the building opening with said panel.

26. The panel system according to claim 25, wherein said upper and lower mounts are made from extruded aluminum.

27. The panel system according to claim 25, further comprising a plurality of nuts attached to the shanks of said fasteners for releasably securing said panel thereto.

28. The panel system according to claim 25, wherein said at least one panel has a plurality of fastener holes defined therein spaced apart along at least one of said lateral edges, the fastener holes being adapted for being placed over a plurality of studs extending from the building along a lateral edge of the building opening so that the at least one lateral edge may be releasably secured to the building by threading nuts onto the studs over the lateral edge of said panel.

29. The panel system according to claim 25, wherein said at least one panel has a plurality of fastener holes defined therein spaced apart along at least one of said lateral edges, the fastener holes being adapted for being aligned with a plurality of anchors mounted in the building along a lateral edge of the building opening so that the at least one lateral edge may be releasably secured to the building by threading fasteners through the fastener holes and into the anchors.

30. The panel attachment system according to claim 24, wherein said at least one panel is formed from corrugated plastic.

31. The panel attachment system according to claim 24, wherein said at least one panel comprises a pair of panels, the system further comprising means for connecting the lateral edges of the pair of panels together in order to cover the building opening with the pair of panels side-by-side.

32. A method of protecting an opening in a building structure from extreme weather conditions, comprising the steps of:
(a) permanently installing an elongated upper track defining a generally downward facing panel edge retaining channel therein, the upper track being installed adjacent an upper edge of the opening;
(b) permanently installing an elongated lower track substantially parallel to the upper track, the lower track defining a channel having a retainer slot extending axially along the channel, the lower track being installed adjacent a lower edge of the opening;
(c) forming at least one protective panel with a plurality of fastener passages disposed adjacent a lower edge thereof;
(d) installing a plurality of panel lower edge fasteners through the fastener passages of the panel, each of the fasteners having a head slidably disposed within the fastener head retaining channel of the lower track and a shank extending through the retainer slot, the shank having a threaded portion extending outwardly from the lower track;
(e) removably installing an upper edge of the at least one panel in the panel edge retaining channel of the upper track;
(f) aligning the panel lower edge fasteners with the fastener passages of the panel;
(g) removably placing the fastener passages of the panel over the shanks of the panel lower edge fasteners; and
(h) removably installing a cooperatively threaded nut over each of the panel lower edge fasteners, thereby removably securing the lower edge of the panel to the lower track.

33. The method of protecting an opening in a building structure according to claim 32, further including the steps of:
(a) forming a plurality of fastener passages adjacent first and second lateral edges of the at least one panel;
(b) removably installing a plurality of lateral edge fasteners through the fastener passages adjacent the first and second lateral edges of the at least one panel; and
(c) removably securing the lateral edges of the panel to the building structure with the lateral edge fasteners.

34. The method of protecting an opening in a building structure according to claim 32, further including the steps of:
(a) forming at least a first panel and a last panel, each of the panels having an outboard edge and at least one panel connector edge opposite the outboard edge;
(b) forming a plurality of fastener passages adjacent the outboard edges of the first panel and last panel;
(c) removably installing a plurality of outboard edge fasteners through the fastener passages adjacent the outboard edges of the first and last panels;
(d) installing at least one elongate panel connector having a first flange, a second flange spaced apart from and parallel to the first flange, and an intermediate web joining the first flange to the second flange, the first flange, second flange, and web defining coplanar, mutually opposed panel connector edge retaining channels therein, to each of the panel connector edges of each of the panels; and
(e) installing the panel connector edge of an adjacent panel to the at least one panel connector of each of the panels.

35. The method of protecting an opening in a building structure according to claim 34, further including the steps of:
(a) forming an inwardly directed bead disposed along the edge of the first flange, thereby defining a narrow connector edge retaining channel; and
(b) permanently installing the narrow connector edge retaining channel to one of the panel connector edges of at least one panel, with the inwardly directed bead of the connector permanently gripping the panel when installed thereon.
